(19) United States
(12) Patent Application Publication
(10) Pub. No.: US 2009/0078043 A1
(43) Pub. Date: Mar. 26, 2009

(54) ROTATION DETECTING DEVICE AND METHOD FOR MANUFACTURING THE SAME

(75) Inventors: Mamoru TSUDA, Kariya-shi (JP); Eiichiro Iwase, Toyoake-shi (JP)

Correspondence Address: BUCHANAN, INGERSOLL & ROONEY PC, POST OFFICE BOX 1404, ALEXANDRIA, VA, 22313-1404, US

(73) Assignee: AISIN SEIKI KABUSHIKI KAISHA, Kariya-shi (JP)

(21) Appl. No.: 12/212,340

(22) Filed: Sep. 17, 2008

(30) Foreign Application Priority Data
Sep. 21, 2007 (JP) 2007-245400

(51) Int. Cl. G01D 11/24; H01B 19/00

(52) U.S. Cl. 73/431; 29/887

(57) ABSTRACT

A rotation detecting device includes a sensor IC, a holder to which the sensor IC is attached, a case body attached to the holder and accommodating the holder and the sensor IC in an internal space of the case body, and a housing accommodating a portion of the case body and the holder. The holder includes a through-hole, which establishes a connection with the internal space of the case body when the case body is attached to the holder. The through-hole is used for injecting a first resin into the internal space of the case body. The injected first resin surrounds the sensor IC in the internal space of the case body. The housing is made of a second resin, which covers the through-hole when the housing is molded with the second resin.

### CROSS REFERENCE TO RELATED APPLICATIONS

This application is based on and claims priority under 35 U.S.C. §119 to Japanese Patent Application 2007-245400, filed on Sep. 21, 2007, the entire contents of which is incorporated herein by reference.

### FIELD OF THE INVENTION

The present invention relates to a rotation detecting device and a method for manufacturing the same.

### BACKGROUND

A conventional rotation detecting device disclosed in JP2005-172573A (Paragraph 0034, FIG. 6) (hereinafter referred to as Patent document 1) includes a sensor IC, a holder to which the IC sensor is attached, a case body attached to the holder and accommodating the holder and the sensor IC in an internal space of the case body, a housing made of resin and formed so as to house at least a portion of the case body and the holder. In the rotation detecting device described in Patent document 1, after lead wires of the sensor IC are connected to a wire harness used for taking out a signal, the connected portion and a portion of an IC package are covered with hot-melt resin. Next, the IC package covered with the hot-melt resin is inserted into the case body, one end portion of which is closed. Further, a base end portion of the case body and a portion of the wire harness are placed in a metal mold. Then, resin is inserted in an internal space of the metal mold (insert molding), thereby molding a housing that covers the base end portion of the case body and the wire harness and that exposes an apical end portion of the case body only. Accordingly, the rotation detecting device is completed. In addition, the resin to be inserted in the internal space of the metal mold used for molding the housing reaches a longitudinal groove that extends close to the apical end portion of the case body along an inner surface of the case body, thereby the coated layer of the hot-melt resin is firmly fixed in the housing. Consequently, the rotation detecting device is configured so as to prevent vibration of the IC package.

However, according to a method for manufacturing the rotation detecting device described in Patent document 1, when the resin for molding the housing is inserted in the internal space of the metal mold in a final manufacturing process (the resin for molding the housing requires a higher filling pressure than the hot-melt resin at this time), the filling pressure of the resin for molding the housing may be partially transmitted to the IC package via the hot-melt resin and the IC package may be damaged due to the transmitted filling pressure.

A need thus exists for a rotation detecting device and a method for manufacturing the same, which are not susceptible to the drawback mentioned above.

### SUMMARY OF THE INVENTION

According to an aspect of the present invention, a rotation detecting device includes a sensor IC, a holder to which the sensor IC is attached, a case body attached to the holder and accommodating the holder and the sensor IC in an internal space of the case body, and a housing accommodating a portion of the case body and the holder. The holder includes a through-hole, which establishes a connection with the internal space of the case body when the case body is attached to the holder. The through-hole is used for injecting a first resin into the internal space of the case body. The injected first resin surrounds the sensor IC in the internal space of the case body. The housing is made of a second resin, which covers the through-hole when the housing is molded with the second resin.

According to an aspect of the present invention, a method for manufacturing a rotation detecting device, which is provided with a sensor IC, a holder to which the sensor IC is attached, a case body attached to the holder and accommodating the holder and the sensor IC in an internal space of the case body, and a housing made of resin and housing a portion of the case body and the holder, includes a process for attaching the case body to the holder in such a way that the sensor IC attached to the holder is accommodated in the internal space of the case body, a process for injecting a first resin into the internal space of the case body through a through-hole, which establishes a connection between the internal space of the case body and the outside when the case body is attached to the holder, so that the first resin surrounds the sensor IC in the internal space of the case body, and a process for molding the housing and covering the through-hole by filling an internal space of a metal mold with a second resin.

### BRIEF DESCRIPTION OF THE DRAWINGS

The foregoing and additional features and characteristics of the present invention will become more apparent from the following detailed description considered with reference to the accompanying figures, wherein:

FIG. 1 illustrates a perspective view of an outer appearance of a rotation detecting device according to an embodiment of the present invention;

FIG. 2 illustrates a perspective view of a metallic terminal and a holder of the rotation detecting device according to the embodiment of the present invention;

FIG. 3A illustrates a schematic plan view of the holder to which a hall IC is attached;

FIG. 3B illustrates a cross-sectional view as seen from the direction of a central axis X of the holder of FIG. 3A;

FIG. 4A is a schematic plan view illustrating a condition before a case body is inserted into the holder;

FIG. 4B is a schematic plan view illustrating a condition where the case body is inserted into the holder;

FIG. 5A is a schematic view of a schematic longitudinal cross-sectional view illustrating a condition where a first resin (hot-melt resin) is injected in the holder;

FIG. 5B is a cross-sectional view taken along line VB-VB of FIG. 5A;

FIG. 6 is a schematic plan view illustrating a condition before a second resin (engineering plastic resin) is filled in a second metal mold; and

FIG. 7 is a schematic plan view illustrating the rotation detecting device taken out from the second metal mold.

### DETAILED DESCRIPTION

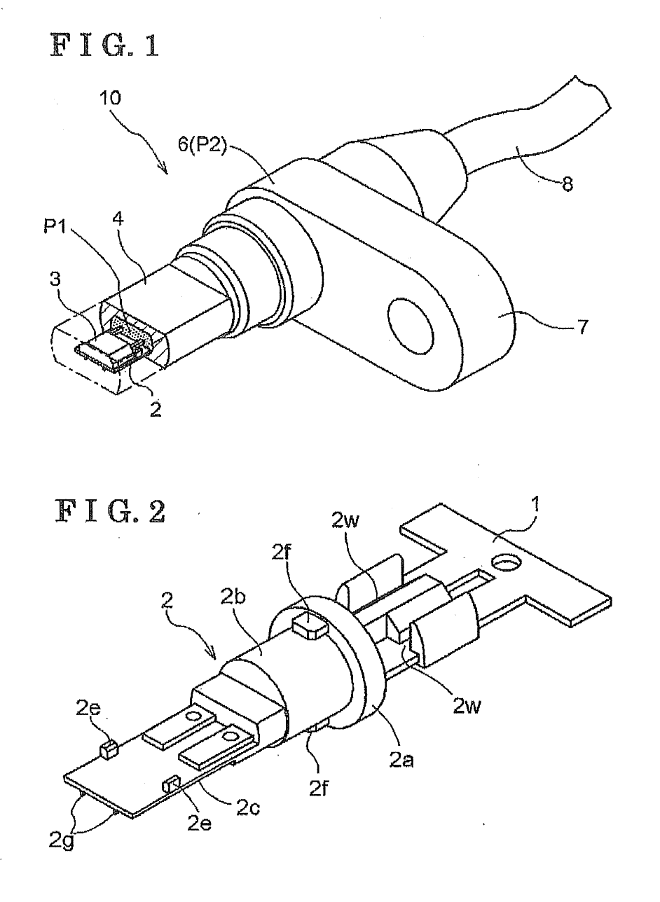

An embodiment of the present invention will be explained with reference to the illustrations of the figures as follows. A rotation detecting device 10 illustrated in FIGS. 1 to 3 includes a hall IC 3 (sensor IC), a holder 2 to which the hall IC 3 is attached, a case body 4 attached to the holder 2 and accommodating the hall IC 3 in an internal space of the case body 4, and a housing 6 formed so as to house a base end portion of the case body 4. In addition, a bracket 7 is formed at a lateral face of the housing 6 so as to be integrated therewith. The bracket 7 serves for fixing the rotation detecting device 10 to locations to be measured such as locations near wheels of a vehicle. A wire harness 8 used for detecting signals is connected to lead plates 3a of the hall IC 3 via a metallic terminal 1 so as to protrude from an end of the housing 6 located on the opposite side of the hall IC 3 as seen in FIG. 1.

A method for manufacturing the rotation detecting device 10 according to the embodiment will be explained as follows. First, as illustrated in FIG. 2, the metallic terminal 1 is positioned relative to a first metal mold (not shown) used for molding the holder 2. The metallic terminal 1 has a pair of terminal posts and a bar-shaped connecting portion with which root portions of the terminal posts are integrated. Engineering plastic resin is filled in an internal space of the first metal mold, thereby insert-molding the holder 2 of the engineering plastic resin to be integrated with the metallic terminal 1. The metallic terminal 1 is positioned relative to the first metal mold by utilizing holes formed near end portions of the terminal posts, respectively and a hole formed near the central part of the connecting portion of the metallic terminal 1.

A disk-shaped flange portion 2a having a first surface and a second surface, a column-shaped boss portion 2b, an IC attaching portion 2c, and a pair of wire harness attaching portions 2w. The first surface and the second surface of the flange portion 2a are molded in the directions of the connecting portion and the end portions of the terminal posts of the metallic terminal 1, respectively. The boss portion 2b protrudes integrally from the second surface of the flange portion 2a. The IC attaching portion 2c protrudes integrally from an end face of the boss portion 2b toward the end portions of the terminal posts of the metallic terminal 1. The wire harness attaching portions 2w are molded to extend on the terminal posts of the metallic terminal 1 from the flange portion 2a to the connecting portion of the metallic terminal 1. IC-supporting projecting portions 2e for supporting and positioning the hall IC 3 are formed on a first surface of the IC attaching portion 2c to which the hall IC 3 is attached as will be described later. In addition, a pair of positioning ribs 2g extending approximately parallel to a central axis X of the holder 2 are molded on a second surface of the IC attaching portion 2c located on the opposite side of the first surface.

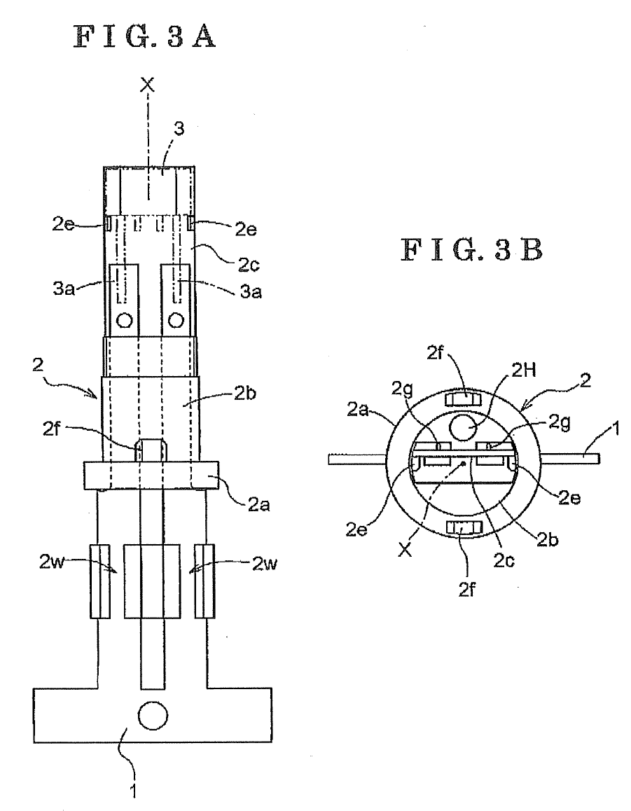

Next, as illustrated in FIG. 3A, the lead plates 3a are welded to the metallic terminal 1 so as to be connected thereto under the condition where an IC package for the hall IC 3 is in contact with end faces of the IC-supporting projecting portions 2e. As illustrated in FIG. 3B, a pair of fitting projecting portions 2f are formed on the second surface of the flange portion 2a. A through-hole 2H used for injecting a first resin P1 such as after-mentioned hot-melt resin is formed in the first surface of the flange portion 2a at a partial area thereof.

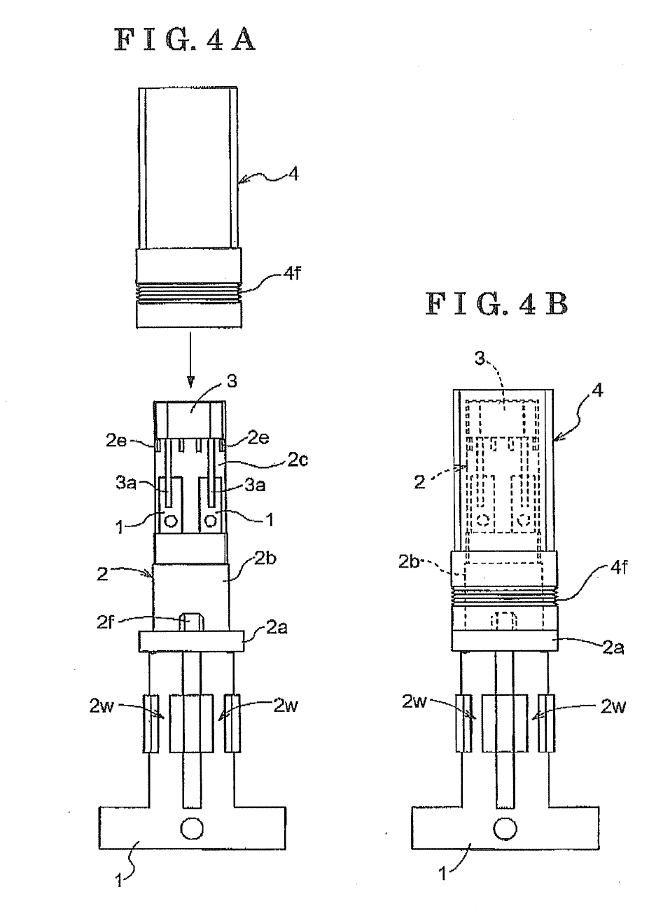

Third, as illustrated in FIG. 4, the IC attaching portion 2c and the boss portion 2b of the holder 2 are inserted into the case body 4 made of engineering plastic resin, which is prepared in advance. During this inserting process, the fitting projecting portions 2f disposed on the second surface of the flange portion 2a are press-fitted into a pair of fitting holes (not shown) formed in the case body 4, thereby positioning the case body 4 relative to the holder 2 while an opening of the case body 4 is closed by the flange portion 2a.

Moreover, the boss portion 2b has an outer peripheral surface fitting an inner peripheral surface of the case body 4. Accordingly, under the condition where the case body 4 is attached to the holder 2, the internal space of the case body 4 is open into the outside via the through-hole 2H only. At this time, the through-hole 2H establishes a connection between the internal space of the case body 4 and the outside.

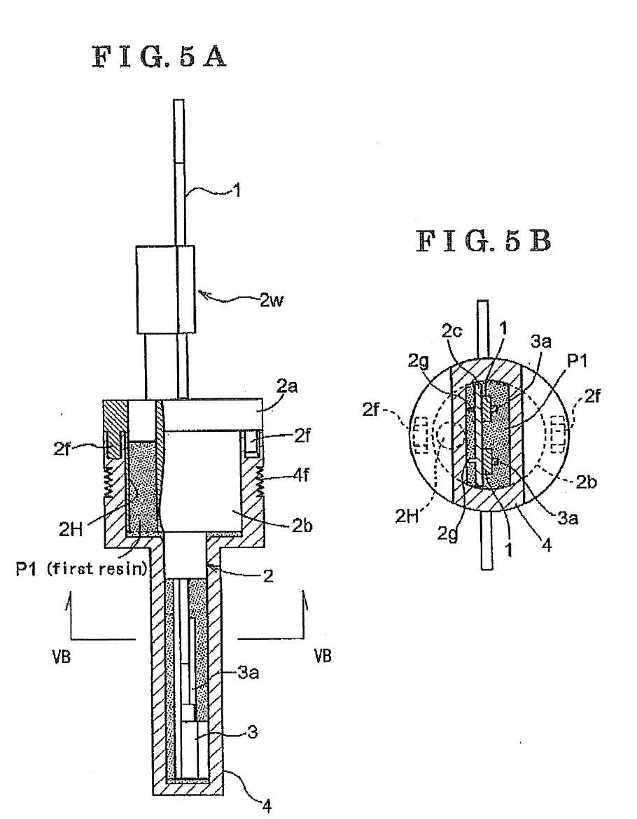

Fourth, as illustrated in FIG. 5A, the first resin P1 is injected through the through-hole 2H into a clearance defined between an inner surface of the case body 4 and the holder 2 within the internal space of the case body 4. The first resin P1 intrudes in a space located between back and lateral surfaces of the hall IC 3 and the inner surface of the case body 4 to be solidified within the case body 4, thereby integrating the case body 4 with the holder 2. Accordingly, the IC package of the hall IC 3 is surely fixed in the internal space of the case body 4. The first resin P1 applied in this injecting process is referred to as a resin consisting primarily of thermoplastic synthetic resin, which obtains fluidity at a comparatively low temperature of 100 degrees C. or more. The synthetic resin is cooled at room temperature to be solidified, thereby bonding a number of members. More specifically, the first resin P1 is filled into the clearance defined between the inner surface of the case body 4 and the holder 2 within the internal space of the case body 4.

In addition, the positioning ribs 2g of the holder 2 are pressed against contacting portions formed in the inner surface of the case body 4 in the above-mentioned process for inserting the holder 2 into the case body 4. Accordingly, the IC package of the hall IC 3 is pressed against an area of the internal surface of the case body 4 located at the opposite side of the positioning ribs 2g, so that the hall IC 3 is temporally fixed to the case body 4. As illustrated in FIG. 5B, the first resin P1 filled in this injecting process intrudes in a space defined between the positioning ribs 2g and the inner surface of the case body 4, thereby positioning the IC attaching portion 2c relative to the case body 4.

Fifth, the bar-shaped connecting portion of the metallic terminal 1 is cut off from the metallic terminal 1. Then, after a portion of a wire junction of the wire harness 8 is pressed against the wire harness attaching portions 2w so as to fit therein, metallic lines of the wire harness 8 are welded to the metallic terminal 1 to be connected thereto.

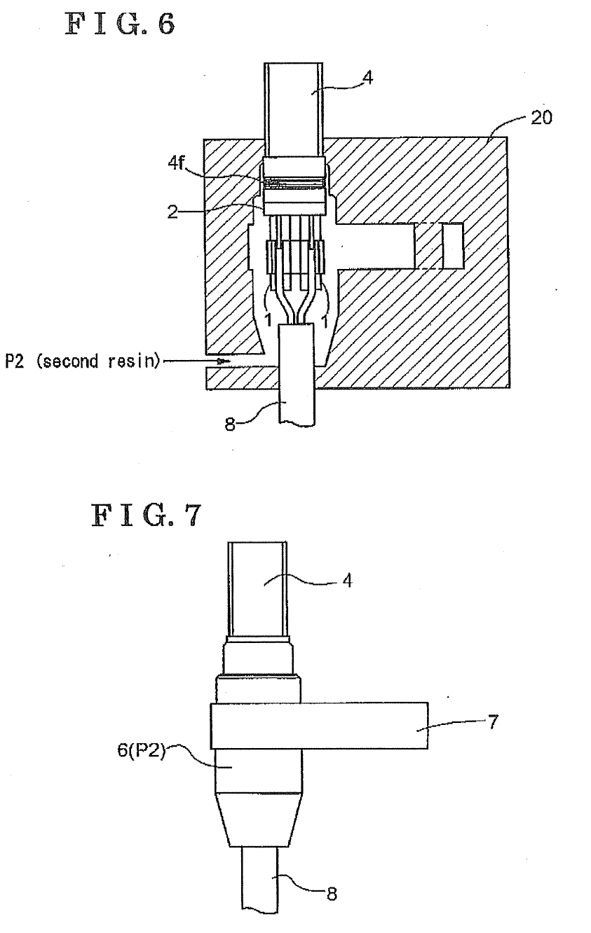

Sixth, as illustrated in FIG. 6, the assembly obtained according to the above-mentioned processes is placed in a second metal mold 20 (metal mold) used for molding the housing 6. Then, a second resin P2 such as engineering plastic resin is filled into an internal space of the second metal mold 20, thereby molding the housing 6 containing a portion of the base end portion of the case body 4, the flange portion 2a of the holder 2, the wire harness attaching portions 2w, the terminal posts of the metallic terminal 1, and a portion of the wire harness 8. Further, the second resin P2 intrudes into a partial area of the through-hole 2H formed in the flange portion 2a of the holder 2 and closes the through-hole 2H. In addition, a melted fold-shaped area 4f having a plurality of thin flanges is formed on a partial area of an outer peripheral surface of the case body 4. The melted fold-shaped area 4f is melted integrally with the second resin P2 to be injected.

The second resin P2 requires a higher filling pressure than the first resin P1. However, the first resin P1 injected into the internal space of the case body 4 is located in a relatively deep area inside the through-hole 2H and does not entirely shield the opening of the through-hole 2H. Further, the through-hole 2H forms an elongated shape. Accordingly, when the second resin P2 is filled into the internal space of the second metal mold 20, the injected first resin P1 near the opening of the through-hole 2H is only partially deformed because transmission of the filling pressure of the second resin P2 is limited only to the surface area of the case body 4. Consequently, the filling pressure of the second resin P2 is not transmitted to the hall IC 3 via the first resin P1.

Seventh, after the second resin P2 is solidified, the second metal mold 20 is split. Then, the rotation detecting device 10 illustrated in FIGS. 1 and 7 is taken out of the second metal mold 20.

In the above-described embodiment, the through-hole 2H used for injecting the first resin P1 into the internal space of the case body 4 is disposed in the flange portion 2a of the holder 2. However, a location in which a through-hole is disposed may not be limited to the flange portion 2a. Thus, the rotation detecting device 10 may be configured as below. For example, a through-hole establishing the connection with the internal space of the case body 4 may be disposed in a lateral surface of the case body 4, which is located near the base end portion of the case body 4. After the first resin P1 is injected into the internal space of the case body 4 through the through-hole, the through-hole may be covered with the second resin P2 to be injected in a subsequent injecting process.

As described above, the hall IC 3 is fixed in the internal space of the case body 4 with the first resin P1 injected into the internal space of the case body 4. In addition, the first resin P1 is injected into the internal space of the case body 4 through the through-hole 2H establishing the connection with the internal space of the case body 4 when the case body 4 is attached to the holder 2. Accordingly, the second resin P2 to be injected into the internal space of the second metal mold 20 in the subsequent injecting process covers the through-hole 2H. Further, a filling pressure required for filling the second resin P2 into the second metal mold 20 may not easily reach the hall IC 3 via the first resin P1, therefore preventing the hall IC 3 from being damaged due to the applied filling pressure.

According to the embodiment, the first resin P1 is hot-melt resin in the rotation detecting device 10.

Accordingly, the first resin P1 is injected into the space defined between the inner surface of the case body 4 and the hall IC 3 within the internal space of the case body 4 with a filling pressure lower than a filling pressure of the second resin P2. Thus, when the first resin P1 is injected into the internal space of the case body 4, excessive pressure may not be applied to the hall IC 3. Consequently, the hall IC 3 is not damaged due to the applied pressure.

According to the embodiment, the holder 2 includes the flange portion 2a closing the opening of the case body 4, and the through-hole 2H is formed in the flange portion 2a.

Accordingly, the through-hole 2H formed in the flange portion 2a of the holder 2 is open into the outside and extends towards an interior side of the internal space of the case body 4. Thus, the first resin P1 is injected into the internal space of the case body 4 with an appropriate filling pressure and reasonably flows through the through-hole 2H due to an additional effect of its weight. Further, when a sufficient thickness is provided to the flange portion 2a, the through-hole 2H is configured to have a sufficiently elongated length. Consequently, the second resin P2 injected in the subsequent injecting process may be much less likely to reach the first resin P1 after passing through the through-hole 2H.

In order to provide the rotation detecting device 10 constructed above, the IC package of the hall IC 3 is surely fixed in the interior space of the case body 4 according to the aforementioned method for manufacturing the rotation detecting device 10. Further, the first resin P1 is injected in the interior space of the case body 4 via the through-hole 2H that establishes the connection between the interior space of the case body 4 and the outside when the case body 4 is inserted into the holder 2. In the subsequent injecting process, the second resin P2 that requires a higher filling pressure than the first resin P1 is injected into the interior space of the second metal mold 20 used for molding the housing 6. Accordingly, when the housing 6 is molded with the second resin P2, the filling pressure required for the second resin P2 is not easily transmitted to the hall IC 3 via the first resin P1, thereby preventing the hall IC 3 from being damaged.

According to the embodiment, in the aforementioned manufacturing method, the holder 2 is molded with the engineering plastic resin so as to be integrated with the metallic terminal 1 connected to the hall IC 3, and the metallic terminal 1 is provided with the connecting portion and a pair of the terminal posts integrally formed with the connecting portion to protrude therefrom.

According to the embodiment, in the aforementioned manufacturing method, the holder 2 is positioned by using the holes formed in the metallic terminal 1 relative to the first metal mold and is insert-molded with the metallic terminal 1 by inserting the engineering plastic resin into the internal space of the first metal mold.

According to the embodiment, in the aforementioned manufacturing method, the holder 2 includes the flange portion 2a closing the opening of the case body 4 and having the through-hole 2H formed in the first surface of the flange portion 2a, and the first resin P1 is injected into the internal space of the case body 4 through the through-hole 2H.

According to the embodiment, in the aforementioned manufacturing method, the holder 2 includes the boss portion 2b having the outer peripheral surface fitting the inner peripheral surface of the case body 4, and the case body 4 is attached to the holder 2 via the boss portion 2b.

According to the embodiment, in the aforementioned manufacturing method, the holder 2 includes the fitting projecting portions 2f disposed on the second surface of the flange portion 2a and the case body 4 includes the fitting holes where the fitting projecting portions 2f fits. Thus, the case body 4 is positioned relative to the holder 2 by press-fitting the fitting projecting portions 2f to the fitting holes.

According to the embodiment, in the aforementioned manufacturing method, the holder 2 includes the IC attaching portion 2c having the first surface to which the hall IC 3 is attached and the second surface provided with the positioning ribs 2g extending parallel to the central axis X of the holder 2. The first surface is on the opposite side of the second surface. Thus, the hall IC 3 is positioned by the positioning ribs 2g relative to the case body 4 so as to be fixed thereto.

According to the embodiment, in the aforementioned manufacturing method, the connecting portion of the metallic terminal 1 is cut off from the metallic terminal 1 and then the lead plates 3a of the hall IC 3 are welded to the metallic terminal 1 to attach the hall IC 3 to the holder 2, thereafter inserting the case body 4 into the holder 2.

According to the embodiment, in the aforementioned manufacturing method, the first resin P1 is injected into the internal space of the case body 4 through the through-hole 2H after the case body 4 is inserted to the holder 2, thereafter solidifying the first resin P1 to integrate the holder 2 with the case body 4.

According to the embodiment, in the aforementioned manufacturing method, the holder 2 integrated with the case body 4 is placed in the second metal mold 20 and the internal space of the second metal mold 20 is filled with the second resin P2.

The principles, preferred embodiment and mode of operation of the present invention have been described in the foregoing specification. However, the invention which is intended to be protected is not to be construed as limited to the particular embodiments disclosed. Further, the embodiments described herein are to be regarded as illustrative rather than restrictive. Variations and changes may be made by others, and equivalents employed, without departing from the spirit of the present invention. Accordingly, it is expressly intended that all such variations, changes and equivalents which fall within the spirit and scope of the present invention as defined in the claims, be embraced thereby.

1. A rotation detecting device, comprising:
a sensor IC;
a holder to which the sensor IC is attached;
a case body attached to the holder and accommodating the holder and the sensor IC in an internal space of the case body; and
a housing accommodating a portion of the case body and the holder;
the holder including a through-hole which establishes a connection with the internal space of the case body when the case body is attached to the holder, the through-hole being used for injecting a first resin into the internal space of the case body, the injected first resin surrounding the sensor IC in the internal space of the case body,
the housing made of a second resin, which covers the through-hole when the housing is molded with the second resin.

2. The rotation detecting device according to claim 1, wherein the first resin is a hot-melt resin.

3. The rotation detecting device according to claim 1, wherein the holder includes a flange portion closing an opening of the case body, and the through-hole is formed in the flange portion.

4. A method for manufacturing a rotation detecting device, the rotation detecting device including a sensor IC, a holder to which the sensor IC is attached, a case body attached to the holder and accommodating the holder and the sensor IC in an internal space of the case body, and a housing made of resin and housing a portion of the case body and the holder, the method comprising:
a process for attaching the case body to the holder in such a way that the sensor IC attached to the holder is accommodated in the internal space of the case body;
a process for injecting a first resin into the internal space of the case body through a through-hole, which establishes a connection between the internal space of the case body and the outside when the case body is attached to the holder, so that the first resin surrounds the sensor IC in the internal space of the case body; and
a process for molding the housing and covering the through-hole by filling an internal space of a metal mold with a second resin.

5. The method for manufacturing the rotation detecting device according to claim 4, wherein the holder is molded with resin so as to be integrated with a metallic terminal connected to the sensor IC, and the metallic terminal is provided with a connecting portion and a pair of terminal posts integrally formed with the connecting portion to protrude therefrom.

6. The method for manufacturing the rotation detecting device according to claim 5, wherein the holder is positioned by using a hole formed in the metallic terminal relative to a metal mold and is insert-molded with the metallic terminal by inserting the resin into an internal space of the metal mold.

7. The method for manufacturing the rotation detecting device according to claim 4, wherein the holder includes a flange portion closing an opening of the case body and having a through-hole formed in a first surface of the flange portion, and a first resin is injected into the internal space of the case body through the through-hole.

8. The method for manufacturing the rotation detecting device according to claim 4, wherein the holder includes a boss portion having an outer peripheral surface fitting an inner peripheral surface of the case body, and the case body is attached to the holder via the boss portion.

9. The method for manufacturing the rotation detecting device according to claim 4, wherein the holder includes a fitting projecting portion disposed on a second surface of the flange portion and the case body includes a fitting hole where the fitting projecting portion fits, and the case body is positioned relative to the holder by press-fitting the fitting projecting portion into the fitting hole.

10. The method for manufacturing the rotation detecting device according to claim 4, wherein the holder includes an IC attaching portion having a first surface to which the sensor IC is attached and a second surface provided with a positioning rib extending parallel to a central axis of the holder, the first surface being on the opposite side of the second surface, and the sensor IC is positioned by the positioning rib relative to the case body so as to be fixed thereto.

11. The method for manufacturing the rotation detecting device according to claim 5, wherein the connecting portion of the metallic terminal is cut off from the metallic terminal and then lead plates of the sensor IC are welded to the metallic terminal to attach the sensor IC to the holder, thereafter inserting the case body into the holder.

12. The method for manufacturing the rotation detecting device according to claim 11, wherein the first resin is injected into the internal space of the case body through the through-hole after the case body is inserted to the holder, thereafter solidifying the first resin to integrate the holder with the case body.

13. The method for manufacturing the rotation detecting device according to claim 12, wherein the holder integrated with the case body is placed in the metal mold and an internal space of the metal mold is filled with a second resin.
